(19) United States
(12) Patent Application Publication
(10) Pub. No.: US 2004/0267520 A1
(43) Pub. Date: Dec. 30, 2004

(54) Audio playback/recording integrated circuit with filter co-processor

(76) Inventor: Roderick Holley II, Pflugerville, TX (US)

Correspondence Address: GARLICK HARRISON & MARKISON LLP, P.O. BOX 160727, AUSTIN, TX, 78716-0727, US

(21) Appl. No.: 10/607,951

(22) Filed: Jun. 27, 2003

(51) Int. Cl. G10L 19/00

(52) U.S. Cl. 704/201

(57) ABSTRACT

An integrated circuit and method of operation used in an audio playback device includes a host interface, a processing module, a multimedia module, a memory, and a filter co-processor. The processing module operably couples to the host interface and the multimedia module operably couples to the processing module. The memory operably couples to the processing module and to the multimedia module in which digital audio information is stored. The filter co-processor operably couples to the processing module and to the memory, wherein at the direction of the processing module the filter co-processor retrieves digital audio information from the memory and filters the digital audio information. In a playback mode, the filter co-processor retrieves the digital audio information from the memory, filters the digital audio information to produce filtered digital audio information, and writes the filtered digital audio information to the memory. In a recording mode the multimedia module receives incoming audio information, converts the incoming audio information to incoming digital audio information, and writes the incoming digital audio information to memory.

### BACKGROUND OF THE INVENTION

1. Technical Field of the Invention

This invention relates generally to portable electronic equipment and more particularly to a multi-function handheld device supporting audio playback and recording operations.

2. Description of Related Art

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension (commonly referred to as a thumb drive), etc. Each of these handheld devices includes one or more integrated circuits to provide the functionality of the device. For example, a thumb drive may include an integrated circuit for interfacing with a computer (e.g., personal computer, laptop, server, workstation, etc.) via one of the ports of the computer (e.g., Universal Serial Bus, parallel port, etc.) and at least one other memory integrated circuit (e.g., flash memory). As such, when the thumb drive is coupled to a computer, data can be read from and written to the memory of the thumb drive. Accordingly, a user may store personalized information (e.g., presentations, Internet access account information, etc.) on his/her thumb drive and use any computer to access the information.

As another example, an MP3 player may include multiple integrated circuits to support the storage and playbacks of digitally formatted audio (i.e., formatted in accordance with the MP3 specification). As is known, one integrated circuit may be used for interfacing with a computer, another integrated circuit for generating a power supply voltage, another for processing the storage and/or playback of the digitally formatted audio data, and still another for rendering the playback of the digitally formatted audio data audible.

Integrated circuits have enabled the creation of a plethora of handheld devices, however, to be “wired” in today's electronic world, a person needs to posses multiple handheld devices. For example, one may own a cellular telephone for cellular telephone service, a PDA for scheduling, address book, etc., one or more thumb drives for extended memory functionality, an MP3 player for storage and/or playback of digitally recorded music, a radio, etc. Thus, even though a single handheld device may be relatively small, carrying multiple handheld devices on one's person can become quite burdensome.

The above-described handheld devices are often used in a non-tethered mode in which they are solely battery powered. The available energy available from the battery is, of course, limited. Thus, it is desirable for the integrated circuits servicing the handheld device to consume as little power as possible while adequately performing required functions. Powering a processor such as a Digital Signal Processor has historically been required to service all operations of the handheld device, which consumes significant power. The processor is underutilized during most operations but continues to consume significant power. Further, in other operations the processor becomes overloaded with basic processing functions, e.g., filtering operations, such that it is unable to service all desired functions.

Thus, a need exists for a handheld device, and an integrated circuit servicing such a handheld device that performs necessary processing functions while extending battery life.

### BRIEF SUMMARY OF THE INVENTION

An integrated circuit (and method of operation) used in an audio playback device includes a host interface, a processing module, a multimedia module, a memory, and a filter co-processor. The processing module operably couples to the host interface and the multimedia module operably couples to the processing module. The memory operably couples to the processing module and to the multimedia module in which digital audio information is stored. The filter co-processor operably couples to the processing module and to the memory, wherein at the direction of the processing module the filter co-processor retrieves digital audio information from the memory and filters the digital audio information.

In one embodiment, the filter co-processor includes a plurality of programmable registers operably coupled to the processing module and a Direct Memory Access (DMA) engine operably coupled to the memory and to the plurality of programmable registers. The filter co-processor also includes a plurality of coefficient register files operably coupled to the DMA engine, a plurality of sample register files operably coupled to the DMA engine, a Multiply Accumulator (MAC) engine operably coupled to the plurality of programmable registers, the plurality of coefficient register files, and the plurality of register files, and an accumulator operably coupled to the MAC engine and to the DMA engine.

The integrated circuit operates in various modes. In a playback mode, the filter co-processor, at the direction of the processing module, retrieves the digital audio information from the memory, filters the digital audio information to produce filtered digital audio information and writes the filtered digital audio information to the memory. Further, the multimedia module receives the filtered digital audio information from memory and converts the filtered digital audio information to a playback format. In the playback mode, the filter co-processor may perform interpolation filtering on the digital audio information to produce the filtered digital audio information. The filter co-processor may also perform graphic equalization filtering on the digital audio information to produce the filtered digital audio information. In performing graphic equalization filtering on the digital audio information, the filter co-processor may perform one of subtractive graphic equalizer filtering in a cascade mode or additive graphic equalizer filtering in a parallel mode.

In a recording mode the multimedia module receives incoming audio information, converts the incoming audio information to incoming digital audio information, and writes the incoming digital audio information to memory. Further, in the recording mode, the filter co-processor, at the direction of the processing module, retrieves the incoming digital audio information from the memory, filters the incoming digital audio information to produce filtered incoming digital audio information and writes the filtered incoming digital audio information to the memory. The filter co-processor may perform decimation filtering on the incoming digital audio information to produce the filtered incoming digital audio information.

The integrated circuit may also include clock control circuitry that varies the frequency of a clock provided to the filter co-processor to thereby adjust the rate at which the filter-co-processor filters the digital audio information. In this structure, the clock may also provided to the processing module with the clock control circuitry also varying the frequency of the clock provided to the processing module. By varying the clock to the components of the integrated circuit, the processing power of the integrated circuit is tailored to meet its processing demands. When processing demands are less, the clock frequency is reduced to reduce power consumption. Alternately, when processing demands are greater the clock frequency is increased to meet the processing demands.

The integrated circuit may also include voltage control circuitry that varies a supply voltage provided to the filter co-processor. The voltage control circuitry may also provide and vary the supply voltage provided to the filter co-processor. By controlling the voltage provided to some or all of the components of the integrated circuit, power consumption of the integrated circuit is reduced while still meeting the processing requirements of the integrated circuit.

During its operations, the integrated circuit may be required to execute a context switch operation. In a context switch operation, the filter co-processor receives a context switch operation from the processing module, ceases its current filtering operations, and initiates differing filtering operations. In performing the context switch, the filter co-processor may save a state of the current filtering operations to memory.

Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a schematic block diagram of a handheld device and corresponding integrated circuit in accordance with an embodiment of the present invention;

FIG. 2 is a schematic block diagram of another handheld device and corresponding integrated circuit in accordance with an embodiment of the present invention;

FIG. 3 is a schematic block diagram of another integrated circuit in accordance with an embodiment of the present invention;

FIG. 4 is a schematic block diagram illustrating a portion of the integrated circuit of FIGS. 1-3 constructed according to an embodiment of the present invention illustrating in particular the structure of a filter co-processor and its interaction with the processing module;

FIG. 5A is a block diagram illustrating audio capture and storage operations;

FIG. 5B is a block diagram illustrating audio playback operations;

FIG. 5C is a logic diagram illustrating operation of the Filter Co-Processor (FILCO) of FIG. 4;

FIG. 6 is a logic diagram illustrating system interaction with the FILCO of FIG. 4;

FIG. 7A is a logic diagram illustrating Finite Impulse Response (FIR) filtering operations of the FILCO of FIG. 4;

FIG. 7B is a logic diagram illustrating Infinite Impulse Response (IIR) filtering operations of the FILCO of FIG. 4;

FIG. 8A is a block diagram illustrating one structure of a FIR filter employed by the FILCO of FIG. 4;

FIG. 8B is a block diagram illustrating one structure of an IIR filter employed by the FILCO of FIG. 4;

FIG. 9 is a block diagram illustrating IIR filtering operations of the FILCO of FIG. 4 in a cascade mode of operation; and

FIGS. 10 is a block diagram illustrating IIR filtering operations of the FILCO of FIG. 4 in a parallel mode of operation.

### DETAILED DESCRIPTION OF THE INVENTION

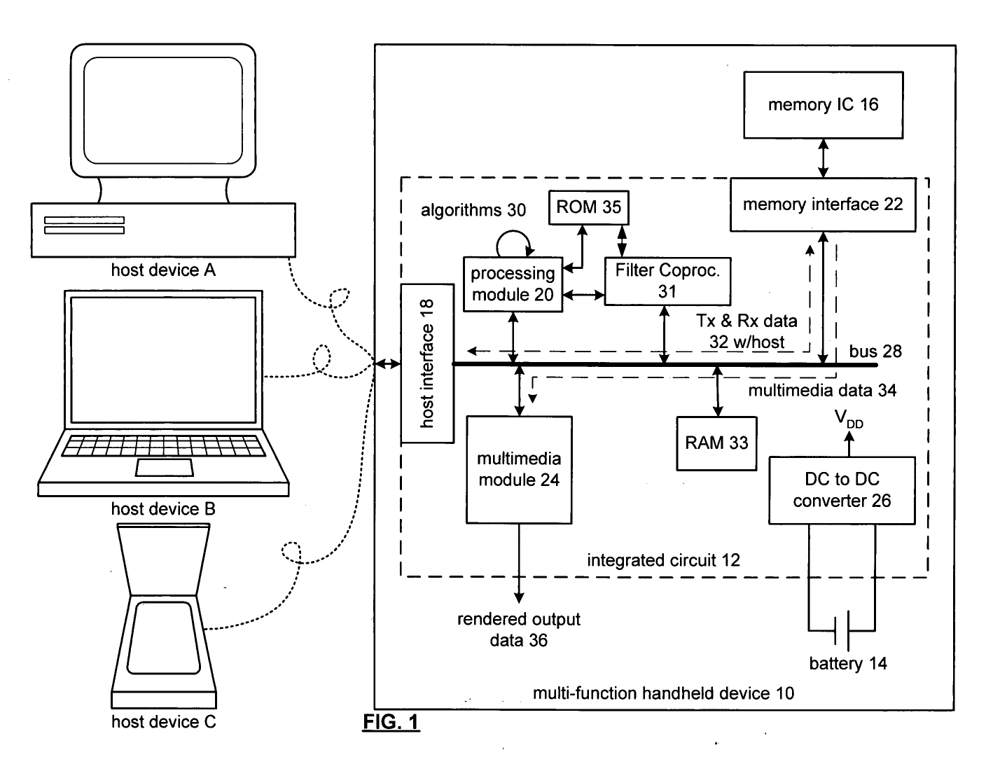

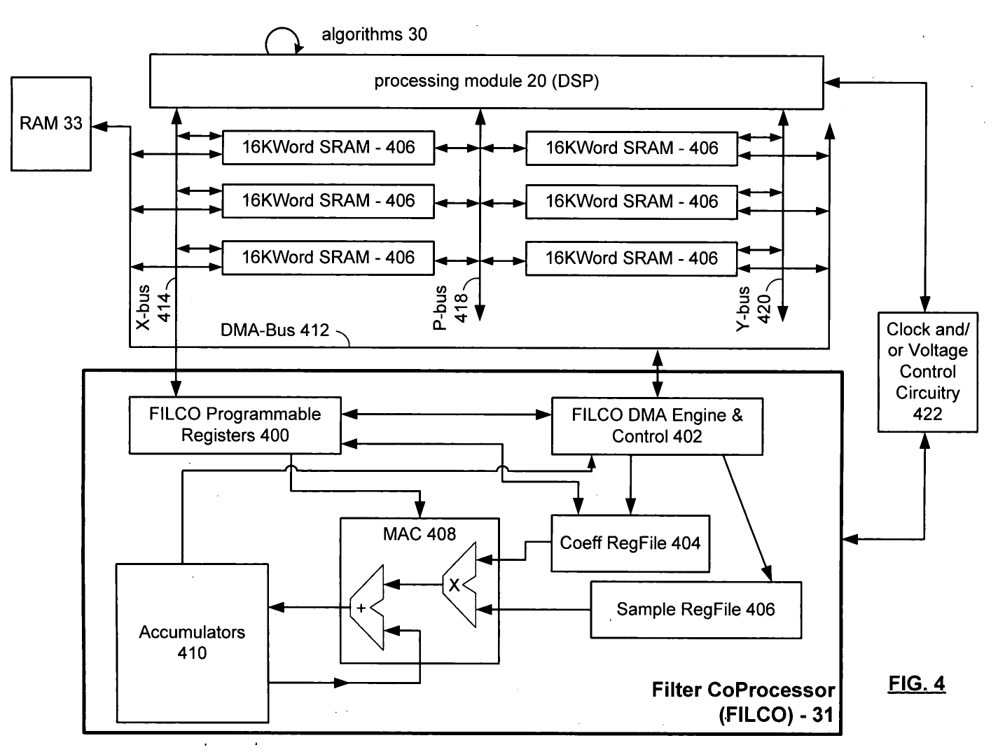

FIG. 1 is a schematic block diagram of a multi-function handheld device 10 and corresponding integrated circuit 12 operably coupled to a host device A, B, or C. The multi-function handheld device 10 also includes memory integrated circuit (IC) 16 and a battery 14. The integrated circuit 12 includes a host interface 18, a processing module 20, a filter co-processor (FILCO) 31, a memory interface 22, a multimedia module 24, a DC-to-DC converter 26, and a bus 28. The multimedia module 24 alone or in combination with the processing module 20 and/or the FILCO 31, provides the functional circuitry for the integrated circuit 12. The FILCO 31 and its operations will be described in detail with reference to FIGS. 4-10. The DC-to-DC converter 26, which may be constructed in accordance with the teaching of U.S. Pat. No. 6,204,651, entitled METHOD AND APPARATUS FOR REGULATING A DC VOLTAGE, provides at least a first supply voltage to one or more of the host interface 18, the processing module 20, the multimedia module 24, the memory interface 22, and the FILCO 31. The DC-to-DC converter 26 may also provide V_{DD} to one or more of the other components of the handheld device 10.

When the multi-function handheld device 10 is operably coupled to a host device A, B, or C, which may be a personal computer, workstation, server (which are represented by host device A), a laptop computer (host device B), a personal digital assistant (host device C), and/or any other device that may transceive data with the multi-function handheld device 10, the processing module 20 performs at least one algorithm 30, where the corresponding operational instructions of the algorithm 30 are stored in memory 16 and/or in memory incorporated in the processing module 20. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

With the multi-function handheld device 10 in the first functional mode, the integrated circuit 12 facilitates the transfer of data between the host device A, B, or C and memory 16, which may be non-volatile memory (e.g., flash memory, disk memory, SDRAM) and/or volatile memory (e.g., DRAM). In one embodiment, the memory IC 16 is a NAND flash memory that stores both data and the operational instructions of at least some of the algorithms 30.

In this mode, the processing module 20 retrieves a first set of operational instructions (e.g., a file system algorithm, which is known in the art) from the memory 16 to coordinate the transfer of data. For example, data received from the host device A, B, or C (e.g., Rx data) is first received via the host interface module 18. Depending on the type of coupling between the host device and the handheld device 10, the received data will be formatted in a particular manner. For example, if the handheld device 10 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 10 is functioning as extended memory of the host device (e.g., like a thumb drive).

In furtherance of the first functional mode, the host device may retrieve data (e.g., TX data) from memory 16 as if the memory were part of the computer. Accordingly, the host device provides a read command to the handheld device 10, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., TX data) is provided to the host interface 18, which converts the format of the retrieved data from the generic format of the handheld device 10 into the format of the coupling between the handheld device 10 and the host device. The host interface 18 then provides the formatted data to the host device via the coupling.

The coupling between the host device and the handheld device 10 may be a wireless connection or a wired connection. For instance, a wireless connection may be in accordance with Bluetooth, IEEE 802.11(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 10 is coupled to the host device via a USB cable, the host interface module 18 includes a USB encoder and a USB decoder.

As one of average skill in the art will appreciate, the data stored in memory 16, which may have 64 Mbytes or greater of storage capacity, may be text files, presentation files, user profile information for access to varies computer services (e.g., Internet access, email, etc.), digital audio files (e.g., MP3 files, WMA—Windows Media Architecture—, MP3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 10 is coupled to the host device A, B, or C, the host device may power the handheld device 10 such that the battery is unused.

When the handheld device 10 is not coupled to the host device, the processing module 20 executes an algorithm 30 to detect the disconnection and to place the handheld device 10 in a second operational mode. In the second operational mode, the processing module 20 retrieves, and subsequently executes, a second set of operational instructions from memory 16 to support the second operational mode. For example, the second operational mode may correspond to MP3 file playback, digital recording, MPEG file playback, JPEG file playback, text messaging display, cellular telephone functionality, and/or AM/FM radio reception. In one or more of these operations, the FILCO 31 may be employed to perform filtering operations.

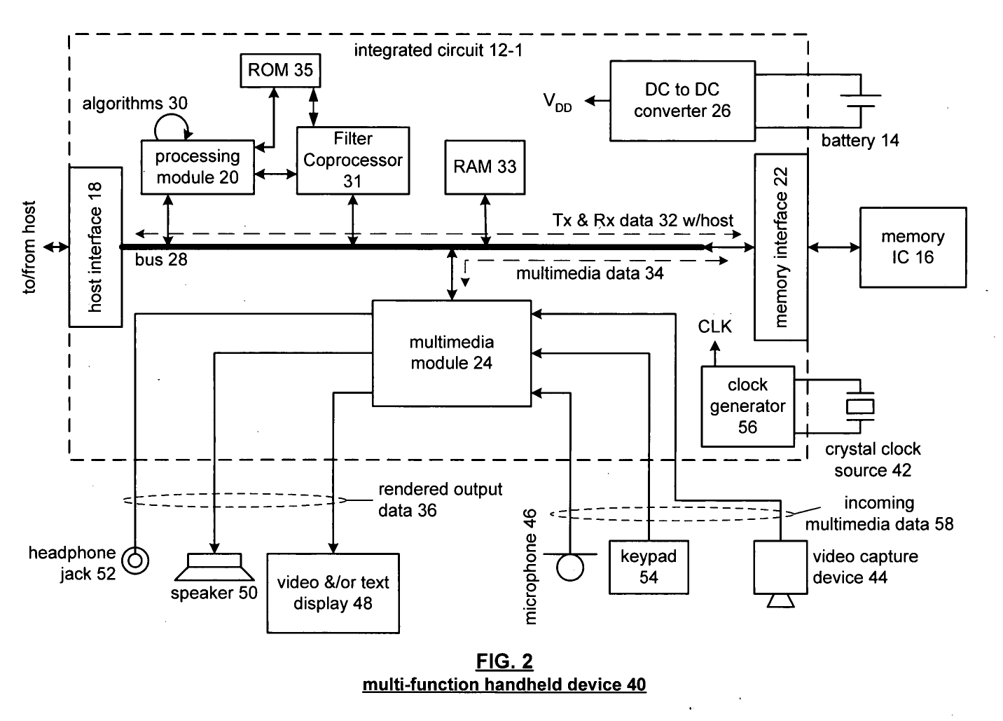

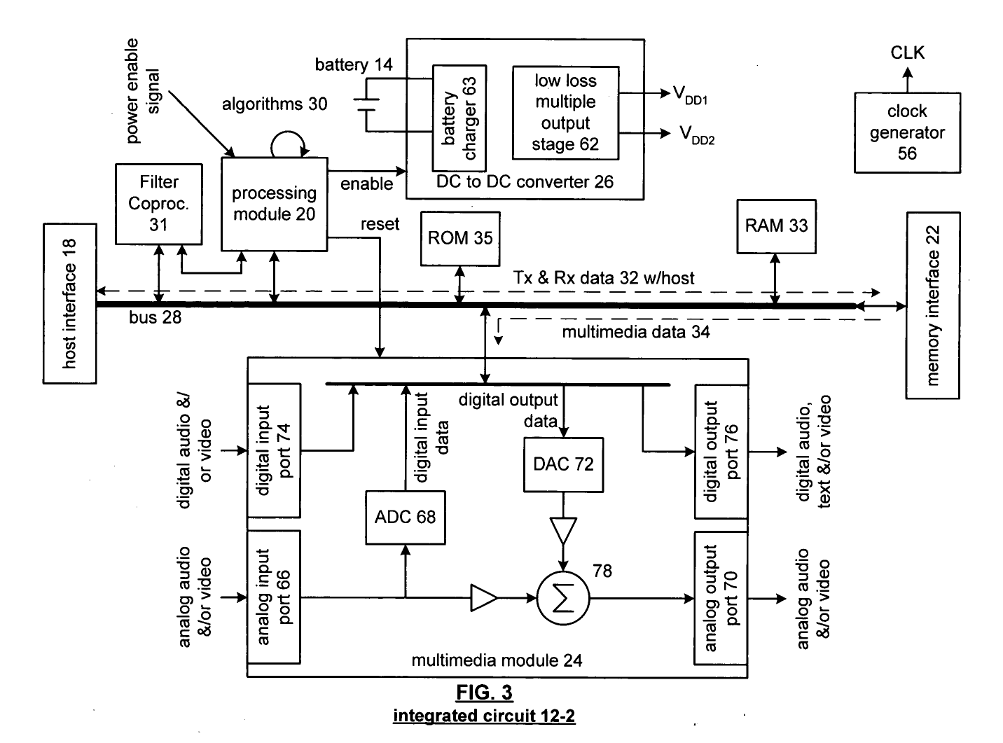

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into analog signals that are subsequently rendered audible via a speaker or via a headphone jack. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display. The multimedia module 24 will be described in greater detail with reference to FIGS. 2 and 3. In at least some of these operations, the FILCO 31 is employed to filter the digital data.

As one of average skill in the art, the handheld device 10 may be packaged similarly to a thumb drive, a cellular telephone, pager (e.g., text messaging), a PDA, an MP3 player, a radio, and/or a digital dictaphone and offer the corresponding functions of multiple ones of the handheld devices (e.g., provide a combination of a thumb drive and MP3 player/recorder, a combination of a thumb drive, MP3 player/recorder, and a radio, a combination of a thumb drive, MP3 player/recorder, and a digital dictaphone, combination of a thumb drive, MP3 player/recorder, radio, digital dictaphone, and cellular telephone, etc.).

FIG. 2 is a schematic block diagram of another handheld device 40 and a corresponding integrated circuit 12-1. In this embodiment, the handheld device 40 includes the integrated circuit 12-1, the battery 14, the memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12-1 includes the host interface 18, the processing module 20, the memory interface 22, the multimedia module 24, the FILCO 31, the DC-to-DC converter 26, and a clock generator 56, which produces a clock signal (CLK) for use by the other modules. As one of average skill in the art will appreciate, the clock signal CLK may include multiple synchronized clock signals at varying rates for the various operations of the multi-function handheld device.

Handheld device 40 functions in a similar manner as handheld device 10 when exchanging data with the host device (i.e., when the handheld device is in the first operational mode). In addition, while in the first operational mode, the handheld device 40 may store digital information received via one of the multimedia input devices 44, 46, and 54. For example, a voice recording received via the microphone 46 may be provided as multimedia input data 58, digitized via the multimedia module 24, and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the keypad 54 (which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

When the handheld device 40 is in the second operational mode (i.e., not connected to the host), the handheld device may record and/or playback multimedia data stored in the memory 16. Note that the data provided by the host when the handheld device 40 was in the first operational mode includes the multimedia data. The playback of the multimedia data is similar to the playback described with reference to the handheld device 10 of FIG. 1. In this embodiment, depending on the type of multimedia data 34, the rendered output data 36 may be provided to one or more of the multimedia output devices. For example, rendered audio data may be provided to the headphone jack 52 an/or to the speaker 50, while rendered video and/or text data may be provided to the display 48. The handheld device 40 may also record multimedia data 34 while in the second operational mode. For example, the handheld device 40 may store digital information received via one of the multimedia input devices 44, 46, and 54.

FIG. 3 is a schematic block diagram of an integrated circuit 12-2 that may be used in a multi-function handheld device. The integrated circuit 12-2 includes the host interface 18, the processing module 20, the DC-to-DC converter 26, the FILCO 31, memory 60, the clock generator 56, the memory interface 22, the bus 28, and the multimedia module 24. The DC-to-DC converter 26 includes a first output section 62, and a second output section 64 to produce a first and second output voltage (V_{DD1} and V_{DD2}), respectively. Typically, V_{DD1} will be greater that V_{DD2}, where V_{DD1} is used to source analog sections of the processing module 20, the host interface 18, the memory interface 22, and/or the multimedia module 22 and V_{DD2} is used to source the digital sections of these modules. The DC-to-DC converter 26 may further include a battery charger 63 and a low loss multiple output stage 62. The battery charger 63 is operable to charge the battery 14 from power it receives via the physical coupling (e.g., via a USB cable) to the host device when the multi-functional handheld device is physically coupled to the host device. The particular implementation of the battery charger 63 is dependent on the type of battery being used and such implementations are known in the art, thus no further discussion will be provided regarding the battery charger 63 except to further illustrate the concepts of the present invention.

The multimedia module 24 includes an analog input port 66, an analog to digital converter (ADC) 68, an analog output port 70, a digital to analog converter (DAC) 72, a digital input port 74, a digital output port 76, and an analog mixing module 78. The analog input port 66 is operably coupled to receive analog input signals from one or more sources including a microphone, an AM/FM tuner, a line in connection (e.g., headphone jack of a CD player), etc. The received analog signals are provided to the ADC 68, which produces digital input data therefrom. The digital input data may be in a pulse code modulated (PCM) format and stored as such, or it may be provided to the processing module 20 for further audio processing (e.g., compression, MP3 formatting, etc.) The digital input data, or the processed version thereof, is stored in memory 16 as instructed by the processing module 20.

The digital input port 74 is operably coupled to receive digital audio and/or video input signals from, for example, a digital camera, a camcorder, etc. The digital audio and/or video input signals may be stored in memory 16 under the control of the processing module 20. As one of average skill in the art will appreciate, the audio and/or video data (which was inputted as analog signals or digital signals) may be stored as raw data (i.e., the signals received are stored as is in designated memory locations) or it may be stored as processed data (i.e., compressed data, MPEG data, MP3 data, WMA data, etc.).

When the output of the DAC 72 is the only input to the mixing module 78, the mixing module 78 outputs the analog video and/or audio output data to the analog output port 70. The analog output port 70 may be coupled to one or more of the speaker, headphone jack, and a video display. The mixing module 78 may mix analog input signals received via the analog input port 66 with the output of DAC 72 to produce a mixed analog signal that is provided to the analog output port 70. Note that the buffers in series with the inputs of the mixing module 78 may have their gains adjusted and/or muted to enable selection of the signals at various gain settings provided to the mixing module 78 and subsequently outputted via the analog output port 70.

The digital output port 76 is operably coupled to output the digital output data (i.e., the multimedia data 34 in a digital format). The digital output port 76 may be coupled to a digital input of a video display device, another handheld device for direct file transfer, etc.

As one of average skill in the art will appreciate, the multimedia module 24 may include more or less components than the components shown in FIG. 3 or include multiple analog and/or digital input and/or output ports. For example, for a playback mode of digital audio files, the multimedia module 24 may only include the DAC 72 and the analog output port 70 that are coupled to the headphone jack and/or to the speaker. As another example, for recording voice samples (i.e., as a digital dictaphone), the multimedia module 24 may include the analog input port 66 coupled to the microphone and the ADC.

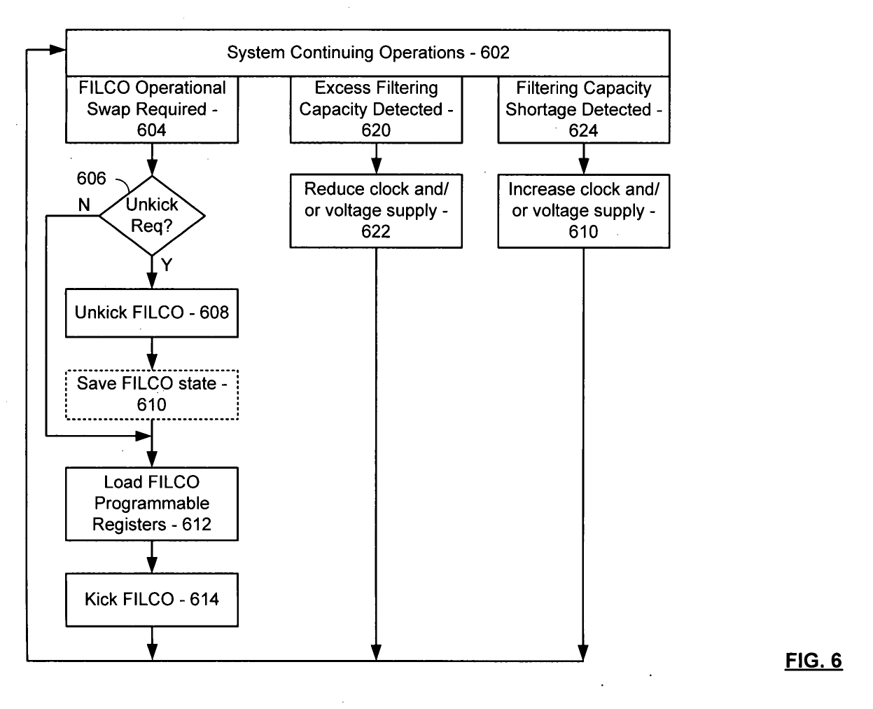

FIG. 4 is a schematic block diagram illustrating a portion of the integrated circuit of FIGS. 1-3 constructed according to an embodiment of the present invention illustrating in particular the structure of a filter co-processor 31 and its interaction with the processing module 20. As shown, the processing module 20 is serviced by three buses, the X-bus 414, the P-bus 418, and the Y-bus 420. SRAM buffers couple to these various buses 414, 418, and 420, as do the RAM 33 and the FILCO 31. Clock and/or voltage control circuitry 422 operably couples to both the processing module 20 and the FILCO 31. As will be described further with reference to FIG. 6, the clock and/or voltage control circuitry 422 may alter the clock and/or voltage supply to the processing module 20 and/or the FILCO 31 to adjust the operation of these devices.

The FILCO 31 includes FILCO programmable registers 400, a FILCO Direct Memory Access (DMA) engine and control 402, coefficient register files 404, sample register files 406, a Multiply Accumulator (MAC) engine 408, and at least one accumulator 410. The components of the FILCO 31 are controlled via the processing module 20 via the X-bus 414 and the FILCO programmable registers 400. The act of initiating filtering operations of the FILCO 31 by the processing module 20 is referred to as a “KICK.” In initiating a KICK, the processing module 20 loads the FILCO programmable registers 400 to indicate a type of filtering to be performed by the FILCO 31, identifies location(s) in the RAM 33 of filter coefficients to be used, and identifies location(s) in the RAM 33 of the samples to be operated upon. Then, the processing module 20 directs the FILCO 31 to proceed with its filter operations.

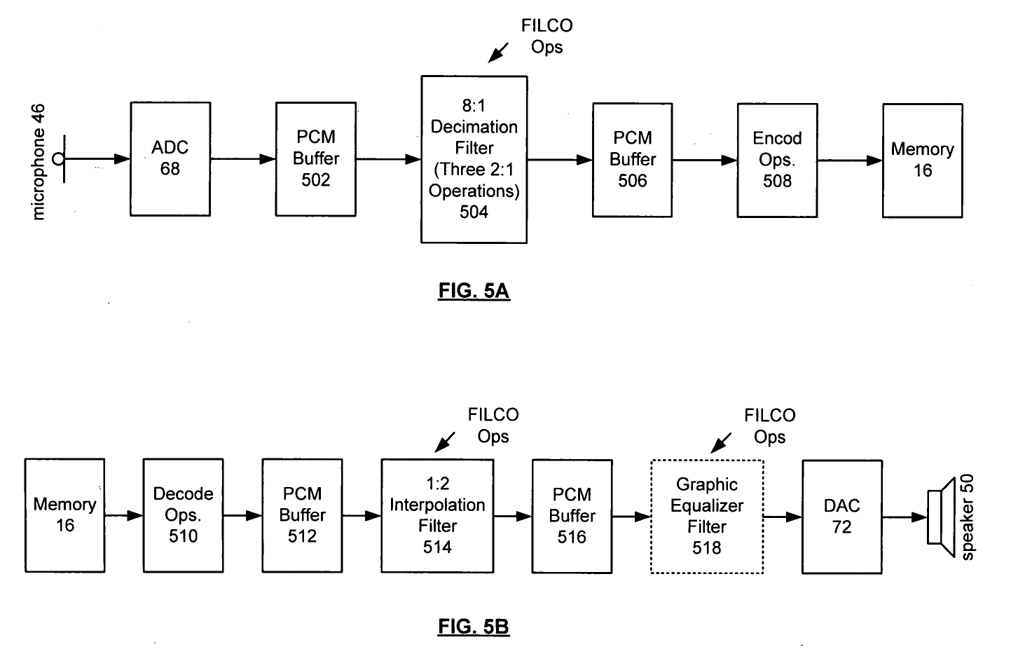

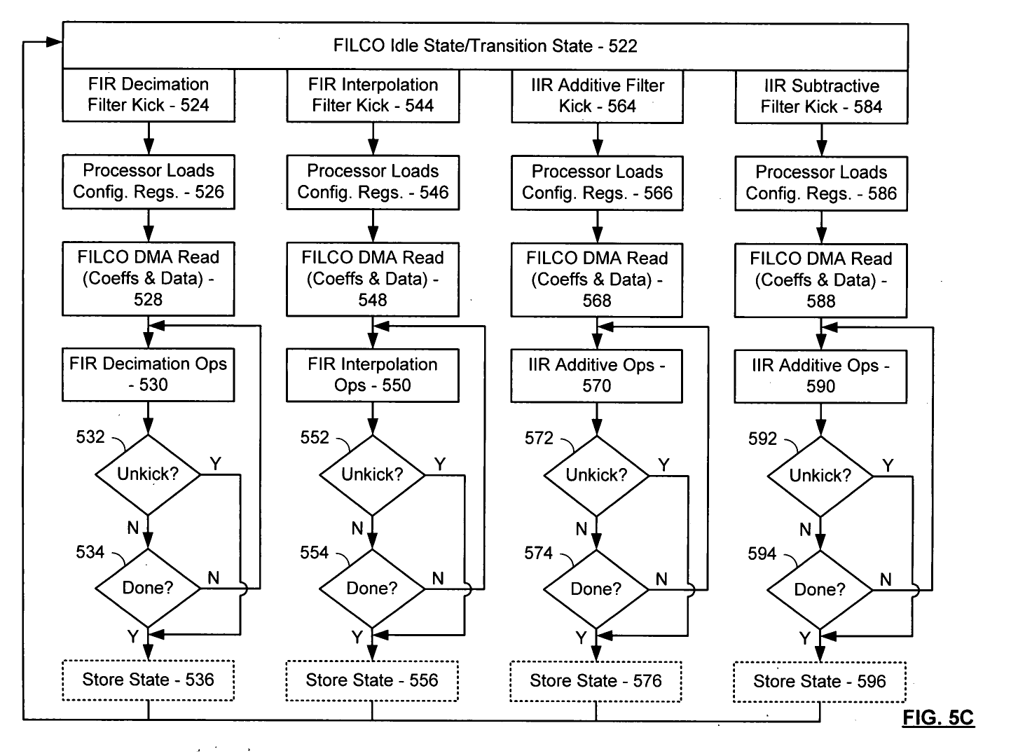

After the FILCO 31 has been “KICKed” by the processing module 20, the FILCO 31 operates based upon the directives it has received via the FILCO programmable registers 400 until it has completed the required operations. Then, the FILCO 31 writes its results to memory 33 and asserts an interrupt to the processing module indicating that it has completed the required tasks. In some situations, the FILCO 31 is required to cease its current operations and perform other operations. This interrupting process is referred to as an “UNKICK.” An UNKICK is initiated by the processing module 20 or another component of the integrated circuit that is responsible for ensuring that the filtering operations of the integrated circuit are met. In an UNKICK, the FILCO 31 may save its state to memory. Alternately, the FILCO 31 may simply write over its state, although the partial filtering operations that were accomplished will be lost. These operations will be described further with reference to FIGS. 5A through 7B.

In the construction illustrated in FIG. 4, the MAC engine 408 includes a 24×24 multiplier while the accumulators 410 include eight (8) 56-bit accumulators. Further, the FILCO 31 can operate upon a plurality of samples at one time, e.g., N=2,3,4,5,6,7,8, . . . , N. When the FILCO 31 implements a Finite Impulse Response (FIR) filter, the FILCO 31 implements variable number of taps that is selected based upon the desired filter, e.g., 0 to 256 or more taps. When the FILCO 31 of the embodiment of FIG. 4 implements an Infinite Impulse Response (IIR) filter, the FILCO 31 implement a fixed number of taps, e.g., 5. However, in other embodiments a differing number of taps may be employed.

FIG. 5A is a block diagram illustrating audio capture and storage operations performed by the integrated circuit. With the described embodiments, the FILCO 31 performs filtering operations in both the playback mode and in the recording mode. FIG. 5A illustrates one example of the manner in which the FILCO 31 operates while the integrated circuit is in the recording mode. In the recording mode the multimedia module 24 receives incoming audio information from a microphone 46, for example. An ADC 68 of the multimedia module 24 converts the incoming audio information to incoming digital audio information, in a Pulse Code Modulated (PCM) format according to the present invention, which is stored in a PCM buffer 502. The PCM buffer 502 is instantiated in the memory 16, RAM 33, or in another memory servicing the device.

The FILCO 31, at the direction of the processing module 20, retrieves the incoming digital audio information from the PCM buffer 502 (in memory), and filters the incoming digital audio information to produce filtered incoming digital audio information 504. The filtered digital audio information is then written to a PCM buffer 506, retrieved by the processing module 20 and encoded according to a supported encoding standard, e.g., MP3. The encoded filtered incoming digital audio information is then stored in memory 16. In one particular operation of FIG. 5A, the FILCO 31 performs decimation filtering on the incoming digital audio information to produce the filtered incoming digital audio information. Such decimation filtering operations may be performed at an 8:1 ratio, with three 2:1 filtering operations performed by the FILCO 31 to achieve the 8:1 decimation process.

FIG. 5B is a block diagram illustrating audio playback operations. In the audio playback mode, digital audio information is retrieved from memory 16, operated upon in a decoding process 510 and written to a PCM buffer 512. The FILCO 31, at the direction of the processing module 20, retrieves the digital audio information from the PCM buffer 512 and filters the digital audio information to produce filtered digital audio information. The filtered digital audio information is then written to an output PCM buffer 516. A DAC 72 of the multimedia module 24 receives the filtered digital audio information from the PCM buffer 516 and converts the filtered digital audio information to a playback format, which is output to speaker 50.

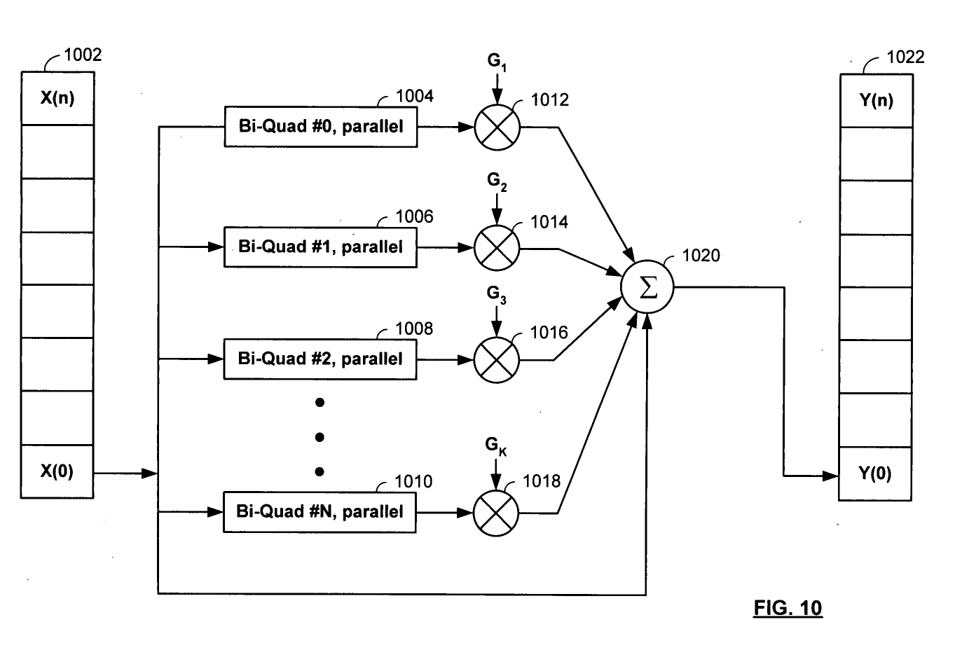

The filtering at operation 514 performed by the FILCO 31 includes a 1:2 interpolation filtering on the digital audio information to produce the filtered digital audio information. Further, the FILCO may also perform graphic equalization filtering at operation 518 on the digital audio information to produce the filtered digital audio information. As will be described further with reference to FIGS. 9 and 10, in performing graphic equalization filtering on the digital audio information, the FILCO 31 performs one of subtractive graphic equalizer filtering in a cascade mode or additive graphic equalizer filtering in a parallel mode.

FIG. 5C is a logic diagram illustrating operation of the Filter Co-Processor (FILCO) of FIG. 4. As illustrated, operation of the FILCO 31 is in an idle state/transition state 522. From state 522 the FILCO 31 may be called upon to perform FIR decimation filtering (step 524), FIR interpolation filtering (step 544), IIR additive filtering (step 564), or IIR subtractive filtering (step 584).

When the FILCO 31 is kicked to perform FIR decimation filtering (step 524), the processor loads the FILCO programmable registers 402 with configuration directives, e.g., type of filter to employ, length of filter, number of samples to operate upon, starting memory location of the filter coefficients, starting memory, location of the samples to filter, etc (step 526). The FILCO 31 then reads the coefficients from memory and writes them to the coefficient register file 404 (step 528). Further at step 528, the FILCO 31 reads the samples from memory and writes them to the sample register file 406. The FILCO 31 then performs FIR decimation filtering operations upon the samples using the coefficients and based upon the filter configuration loaded into the FILCO programmable register 402 (step 530). At step 532 the FILCO 31 determines whether the processing module 20 has issued an UNKICK to the FILCO 31. If not, operation proceeds to step 534 where the FILCO 31 determines whether it has completed the assigned filtering tasks. If the filtering tasks are not completed, operation returns to step 530. However, if the FILCO 31 is done with the assigned tasks the results are written to memory 16. Alternately, if the FILCO 31 has been UNKICKED by the processing module 20, the FILCO 31 may or may not save its state for future reference, depending upon the particular embodiment (step 536).

When the FILCO 31 is kicked to perform FIR interpolation filtering (step 544), the processor loads the FILCO programmable registers 402 with configuration directives (step 546). The FILCO 31 then reads the coefficients from memory and writes them to the coefficient register file 404 (step 548). Further at step 548, the FILCO 31 reads the samples from memory and writes them to the sample register file 406. The FILCO 31 then performs FIR interpolation filtering operations upon the samples using the coefficients and based upon the filter configuration loaded into the FILCO programmable register 402 (step 550). At step 552 the FILCO 31 determines whether the processing module 20 has issued an UNKICK to the FILCO 31. If not, operation proceeds to step 554 where the FILCO 31 determines whether it has completed the assigned filtering tasks. If the filtering tasks are not completed, operation returns to step 550. However, if the FILCO 31 is done with the assigned tasks the results are written to memory 16. Alternately, if the FILCO 31 has been UNKICKED by the processing module 20, the FILCO 31 may or may not save its state for future reference, depending upon the particular embodiment (step 536).

When the FILCO 31 is kicked to perform IIR additive filtering (step 564), the processor loads the FILCO programmable registers 402 with configuration directives (step 566). The FILCO 31 then reads the coefficients from memory and writes them to the coefficient register file 404 (step 568). Further at step 568, the FILCO 31 reads the samples from memory and writes them to the sample register file 406. The FILCO 31 then performs IIR additive filtering operations upon the samples using the coefficients and based upon the filter configuration loaded into the FILCO programmable register 402 (step 570). At step 572 the FILCO 31 determines whether the processing module 20 has issued an UNKICK to the FILCO 31. If not, operation proceeds to step 574 where the FILCO 31 determines whether it has completed the assigned filtering tasks. If the filtering tasks are not completed, operation returns to step 570. However, if the FILCO 31 is done with the assigned tasks the results are written to memory 16. Alternately, if the FILCO 31 has been UNKICKED by the processing module 20, the FILCO 31 may or may not save its state for future reference, depending upon the particular embodiment (step 576).

When the FILCO 31 is kicked to perform IIR subtractive filtering (step 584), the processor loads the FILCO programmable registers 402 with configuration directives (step 5686). The FILCO 31 then reads the coefficients from memory and writes them to the coefficient register file 404 (step 588). Further at step 588, the FILCO 31 reads the samples from memory and writes them to the sample register file.406. The FILCO 31 then performs IIR subtractive filtering operations upon the samples using the coefficients and the filter configuration loaded into the FILCO programmable register 402 (step 590). At step 592 the FILCO 31 determines whether the processing module 20 has issued an UNKICK to the FILCO 31. If not, operation proceeds to step 594 where the FILCO 31 determines whether it has completed the assigned filtering tasks. If the filtering tasks are not completed, operation returns to step 590. However, if the FILCO 31 is done with the assigned tasks the results are written to memory 16. Alternately, if the FILCO 31 has been UNKICKED by the processing module 20, the FILCO 31 may or may not save its state for future reference, depending upon the particular embodiment (step 596).

The pipelining of data through the use of eight accumulators 410 and the sample/coefficient register files 402 and 404 helps reduce the number of DMA accesses by re-using samples and coefficients efficiently. Instead of reading all N taps and 2N samples per output sample pair generated, the FILCO 31 reads (N taps+# of zero fill*) and 2N samples for four output sample pairs generated. For FIR interpolation operations, three zero fills are required. For FIR decimation operations, six zero fills are required. This decreases the load on the DMA bus 412 helping overall system performance.

FIG. 6 is a logic diagram illustrating system interaction with the FILCO of FIG. 4. Operation commences during normal system continuing operations (step 602). When a FILCO 31 operational swap is required (step 604), e.g., from IIR additive filtering to FIR decimation filtering the processing module 20 determines whether an UNKICK is required (step 606). If an UNKICK is required, the processing module 20 issues an UNKICK command to the FILCO 31 (step 608) and resultantly the FILCO 31 responds to the UNKICK command by UNKICKing its operations, in some cases also with saving its state (step 610). From both step 610 and if an UNKICK is not required (as determined at step 606), operation proceeds to step 612 wherein the processing module 20 loads the FILCO programmable registers 400 with the desired filtering configuration information (step 612). The processing module 20 then KICKS the FILCO 31 to initiate the new filtering operations.

A context switch (step 604) may result when a buffer underflow condition is detected during a playback mode operation. In such case, the buffer cannot become vacant. Thus, if the processing module 20 detects such an underflow condition, it will KICK the FILCO 31 to perform the required filtering operations. Alternately, during a recording mode operation a buffer overflow condition may be detected. In such case, the processing module 20 detects the overflow condition and may KICK the FILCO 31 to perform required filtering operations.

In some operations, e.g., playback mode, idle mode, etc. the full processing capabilities of the FILCO 31 and/or the processing module 20 are not required. In such case, the processing module 20 (or another integrated circuit component) detects that excess filtering capacity exists considering current filtering requirements (step 620). In such case, the clock frequency provided to the FILCO 31 and/or processing module 20 is reduced. Alternately, the supply voltage provided to the FILCO 31 and/or the processing module 20 is reduced.

When the supply voltage to the FILCO 31 has been reduced and/or the clock frequency provided to the FILCO 31 and/or the processing module 20 has been reduced, a filtering capacity shortfall may be detected (step 624). When this shortfall is detected, the supply voltage and/or the clock frequency provided to the FILCO 31 and/or the processing module 20 is increased (step 610).

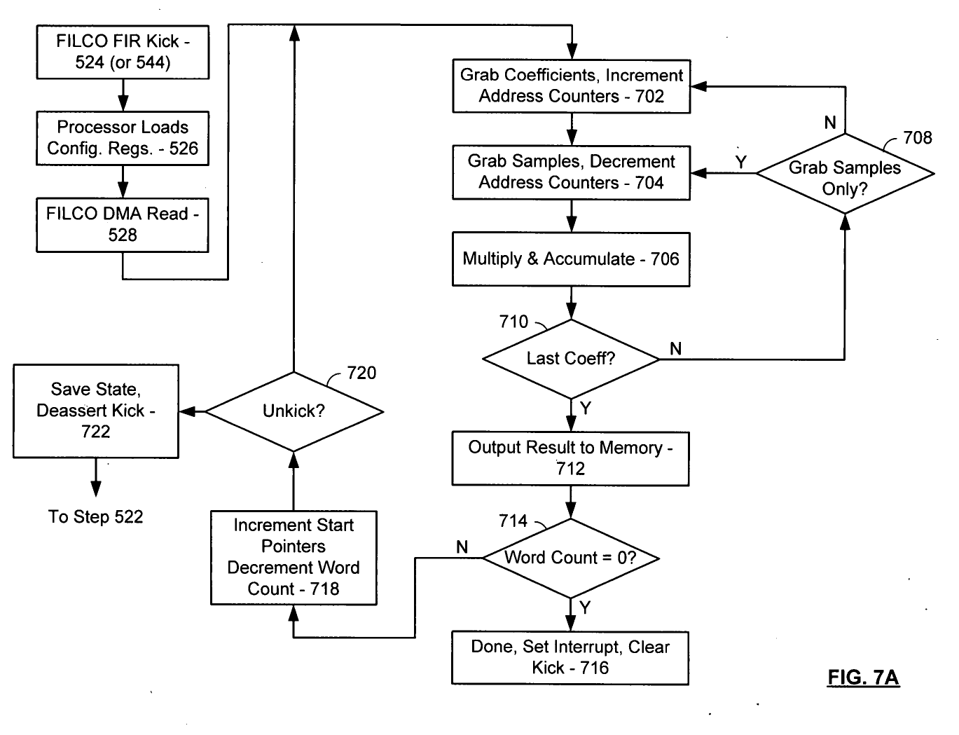

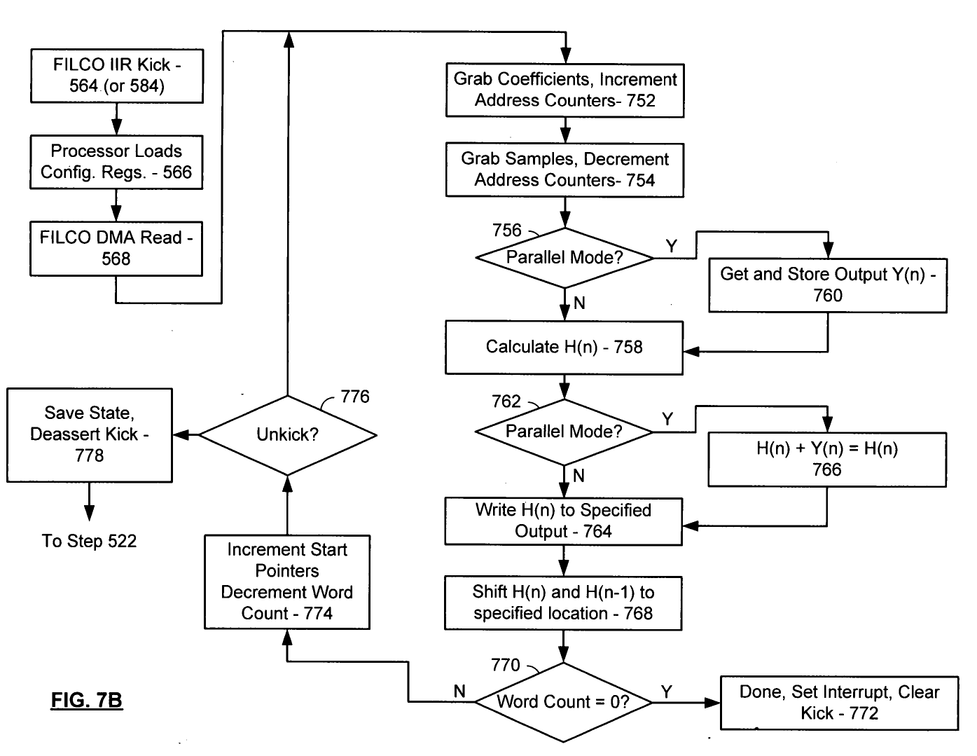

FIG. 7A is a logic diagram illustrating Finite Impulse Response (FIR) filtering operations of the FILCO of FIG. 4. Operation commences with the processing module 20 KICKing the FILCO 31 to perform the FIR filtering operations (step 524 or 544 of FIG. 5). The processing module 20 then loads the FILCO configuration registers 400 (step 526) and the FILCO DMA engine 402 reads memory 16 to access the filter coefficients and samples that are to be filtered (step 528). The FILCO 31 then sets a word count to the number of words to be operated upon in the FIR filtering process.

For the particular MAC operations to be performed the coefficients are grabbed (step 702), the samples are grabbed (step 704), and a MAC operation is performed (step 706). With the particular MAC operation performed it is next determined whether the last coefficient has been operated upon for the current sample(s) (step 710). If not, it is next determined whether the next MAC operation requires only new sample(s) (step 708). If so, operation proceeds to step 704. If both coefficients and samples are required (as determined at step 708), operation proceeds to step 702.

From step 710 operation proceeds to step 712 wherein the FILCO 31 outputs the result of the MAC operations to memory. Then, the FILCO 31 determines whether the word count for the FIR operations has reached zero, i.e., the operations are complete for the current KICK (step 714). If so, the operations are completed, the FILCO 31 sets an interrupt indicating that its operations are complete and the KICK is cleared (step 716). If not, operation proceeds to step 718 where the start pointers are incremented and the word count is decremented. Then, the FILCO 31 determines whether it has been UNKICKED by the processing module 20 (step 720). If not, operation returns to step 702. If so, the FILCO 31 saves its state and de-asserts the KICK (step 722). From step 722, operation proceeds to step 522 of FIG. 5.

FIG. 7B is a logic diagram illustrating Infinite Impulse Response (IIR) filtering operations of the FILCO of FIG. 4. Operation commences with the processing module 20 KICKing the FILCO 31 to perform the IIR filtering operations (step 564 or 584 of FIG. 5). The processing module 20 then loads the FILCO configuration registers 400 (step 566) and the FILCO DMA engine 402 reads memory 16 to access the filter coefficients and samples that are to be filtered (step 568). The FILCO 31 then sets a word count to the number of words to be operated upon in the IIR filtering process.

For the particular MAC operations to be performed the coefficients are grabbed (step 752) and the samples are grabbed (step 754). The FILCO 31 next determines whether a parallel (additive) IIR mode is to be used (step 756). If the FILCO 31 is operating in the parallel mode, the FILCO 31 gets and stores the output Y(n) (step 760). If the FILCO 31 is no operating in the parallel mode, from step 756 operation proceeds to step 758 (as it does from step 760).

At step 758, the FILCO 31 performs a MAC operation to determine H(n) (step 758). The FILCO 31 then determines again whether the parallel (additive) IIR mode is used (step 762). If the parallel mode is being used, the FILCO 31 calculates H(n)=Y(n)+H(n) (step 766). If the FILCO 31 is not operating in the parallel mode, operation proceeds to step 764 as it does from step 766 where the FILCO 31 writes H(n) to a specified output. The FILCO 31 then shifts H(n) and H(n−1) to a specified location (step 768).

The FILCO 31 next determines whether the word count for the IIR operations has reached zero, i.e., the operations are complete for the current KICK (step 770). If so, the operations are completed, the FILCO 31 sets an interrupt indicating that its operations are complete and the KICK is cleared (step 772). If not, operation proceeds to step 774 where the start pointers are incremented and the word count is decremented. Then, the FILCO 31 determines whether it has been UNKICKED by the processing module 20 (step 776). If not, operation returns to step 752. If so, the FILCO 31 saves its state and de-asserts the KICK (step 778). From step 778, operation proceeds to step 522 of FIG. 5.

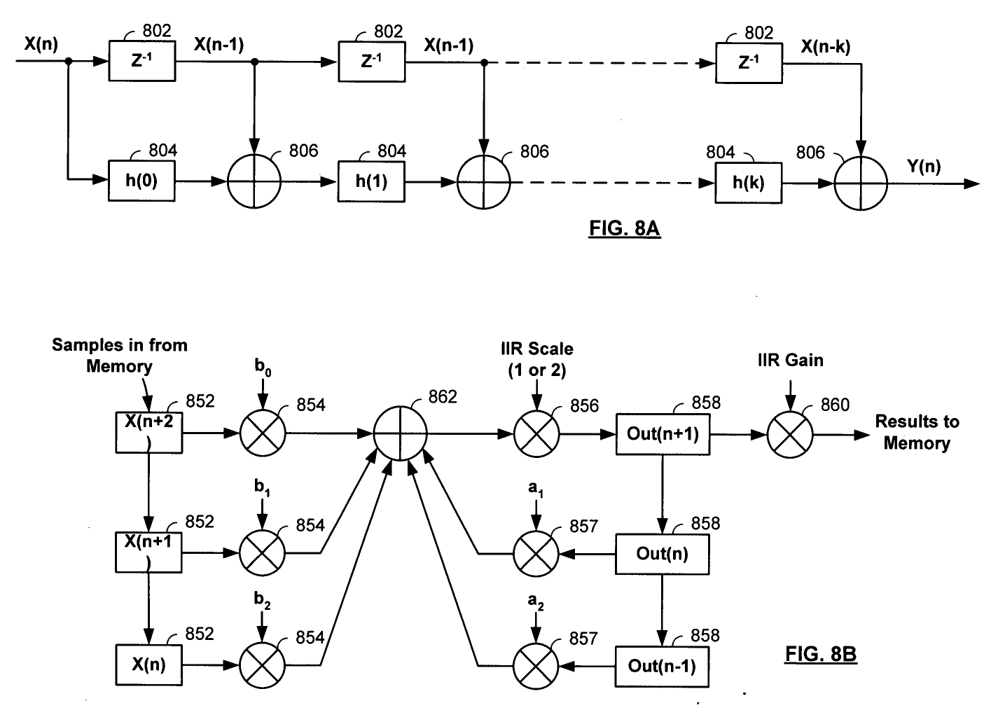

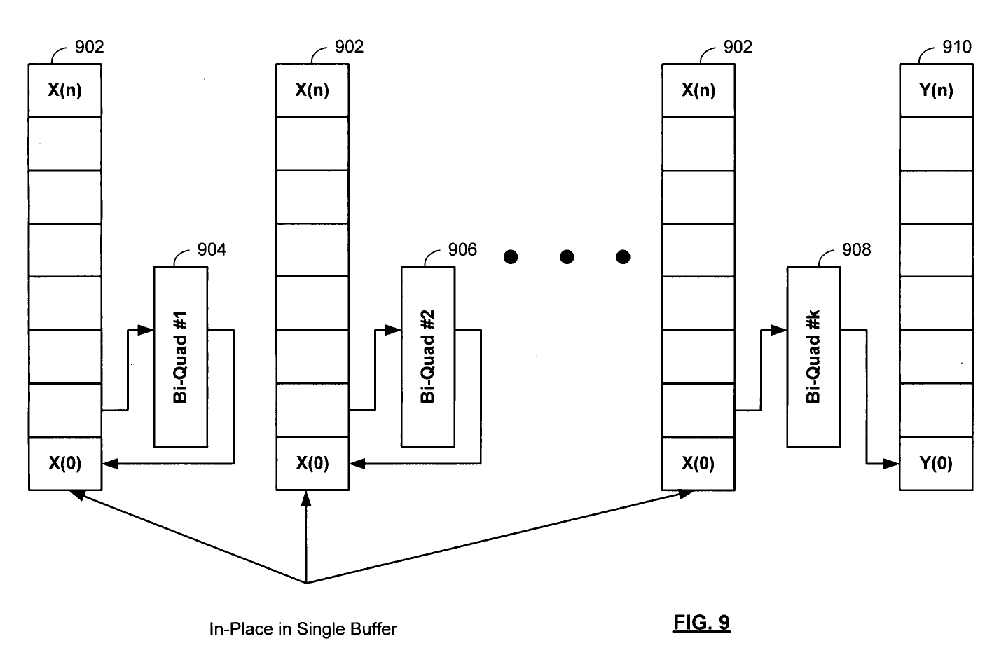

FIG. 8A is a block diagram illustrating one structure of a FIR filter employed by the FILCO of FIG. 4. The FIR filter includes a plurality of delay elements 802, a plurality of gain elements 804, and a plurality of summers 806. The FIR filter of FIG. 8A has K taps.

FIG. 8B is a block diagram illustrating one structure of an IIR filter employed by the FILCO of FIG. 4. The IIR filter is of a Bi-Quad design and includes a plurality of sample buffers 852 and a plurality of multipliers 854 that multiply the plurality of samples stored in the sample buffers 852 by filter coefficients b₀, b₁, b₂. A summer 862 receives the outputs from the multipliers 854 and also outputs from multipliers 857. Multipliers 857 produce outputs based upon contents of output sample buffers 859 and coefficients a₁ and a₂. The output of the summer 862 is produced to multiplier 856, which multiplies the output by a scaling factor to produce an output sample at buffer 858. An IIR gain is applied to the output sample buffer 858 contents to produce results of the IIR filter that are stored in memory. FILCO supports Bi-Quadratic IIR filter modes for both additive and subtractive graphic equalizer implementations.

FIG. 9 is a block diagram illustrating IIR filtering operations of the FILCO of FIG. 4 in a cascade mode of operation. With the subtractive mode equalizer (IIR filter) a single buffer 902 is used for multiple passes of each stage/band of the equalizer. Each time the bi-quad filter is run to process a band, both the input and the output are set to point to the same circular buffer for operation by the BI-Quad filter 904, 906, etc. The filter coefficients are set for the first band and the filter is KICKed off. The filter coefficients for this case are set for notch filtering, i.e. potentially reducing the amplitude of any frequency components within its pass band. Out-of-band frequency components are essentially unmodified. Thus, frequency components within the band are effectively “subtracted” from the composite signal. This is counter intuitive to what is displayed on the user interface of a graphic equalizer but an effective implementation technique. For the final filter/channel bank run for the equalizer 908, one can choose to point the results back in to the same buffer for in-place computation or one can use this filter operation to also copy the result to another circular buffer 910 (as illustrated).

FIG. 10 is a block diagram illustrating IIR filtering operations of the FILCO of FIG. 4 in a parallel mode of operation. The K-band additive graphic equalizer model of FIG. 4 uses a different operation upon input buffer 1002 samples. In this case, each IIR filter operation 1004, 1006, 1008, . . . 1010 is set as a band pass filter so that the frequency components outside of its pass band are strongly suppressed. Using gain elements 1012, 1014, 1016, . . . , 1018 the components lying inside a pass band are copied to the output buffer 1022 where the components from all banks are super positioned with the summation operator 1020. This form of the equalizer (IIR filter) is used when all bands are computed in parallel and results are simultaneously available from all filter banks 1002.

In the parallel mode, each filter bank is run as a separate KICK. For a five-bank equalizer there are five separate IIR filters to run and each IIR filter 1004-1010 runs to completion before the next one is started. In parallel mode, just as a filter output sample is computed, it is added to the value in the output sample array 1022. Thus the superposition of all filter banks is formed in the output buffer 1022 where all filter results for a given sample are added together.

The preceding discussion has presented a host interface for a system-on-a-chip integrated circuit. As one of average skill in the art will appreciate, other embodiments may be derived from the teaching of the present invention, without deviating from the scope of the claims.

1. An integrated circuit used in an audio playback device, the integrated circuit comprising:
a host interface;
a processing module operably coupled to the host interface;
a multimedia module operably coupled to the processing module;
memory operably coupled to the processing module and to the multimedia module in which digital audio information is stored; and
a filter co-processor operably coupled to the processing module and to the memory, wherein at the direction of the processing module the filter co-processor retrieves digital audio information from the memory and filters the digital audio information.

2. The integrated circuit of claim 1, wherein the filter co-processor comprises:
a plurality of programmable registers operably coupled to the processing module;
a Direct Memory Access (DMA) engine operably coupled to the memory and to the plurality of programmable registers;
a plurality of coefficient register files operably coupled to the DMA engine;
a plurality of sample register files operably coupled to the DMA engine;
a Multiply Accumulator (MAC) engine operably coupled to the plurality of programmable registers, the plurality of coefficient register files, and the plurality of register files; and
an accumulator operably coupled to the MAC engine and to the DMA engine.

3. The integrated circuit of claim 1, wherein when the integrated circuit operates in a playback mode:
the filter co-processor, at the direction of the processing module, retrieves the digital audio information from the memory, filters the digital audio information to produce filtered digital audio information and writes the filtered digital audio information to the memory; and
the multimedia module receives the filtered digital audio information from memory and converts the filtered digital audio information to a playback format.

4. The integrated circuit of claim 3, wherein the filter co-processor performs interpolation filtering on the digital audio information to produce the filtered digital audio information.

5. The integrated circuit of claim 3, wherein the filter co-processor performs graphic equalization filtering on the digital audio information to produce the filtered digital audio information.

6. The integrated circuit of claim 5, wherein in performing graphic equalization filtering on the digital audio information, the filter co-processor performs one of subtractive graphic equalizer filtering in a cascade mode or additive graphic equalizer filtering in a parallel mode.

7. The integrated circuit of claim 1, wherein when the integrated circuit operates in a recording mode:
the multimedia module receives incoming audio information, converts the incoming audio information to incoming digital audio information, and writes the incoming digital audio information to memory; and
the filter co-processor, at the direction of the processing module, retrieves the incoming digital audio information from the memory, filters the incoming digital audio information to produce filtered incoming digital audio information and writes the filtered incoming digital audio information to the memory.

8. The integrated circuit of claim 7, wherein the filter co-processor performs decimation filtering on the incoming digital audio information to produce the filtered incoming digital audio information.

9. The integrated circuit of claim 1, further comprising clock control circuitry that varies the frequency of a clock provided to the filter co-processor to thereby adjust the rate at which the filter-co-processor filters the digital audio information.

10. The integrated circuit of claim 9, wherein:
the clock is also provided to the processing module; and
the clock control circuitry also varies the frequency of the clock provided to the processing module.

11. The integrated circuit of claim 1, further comprising voltage control circuitry that varies a supply voltage provided to the filter co-processor.

12. The integrated circuit of claim 11, wherein the voltage control circuitry also provides and varies the supply voltage provided to the filter co-processor.

13. The integrated circuit of claim 1, wherein in a context switch operation, the filter co-processor receives a context switch operation from the processing module, ceases its current filtering operations, and initiates differing filtering operations.

14. The integrated circuit of claim 13, wherein in the context switch operation, the filter co-processor saves a state of the current filtering operations to memory.

15. A method for operating an audio playback device comprising:
receiving digital audio information via a host interface;
storing the digital audio information in memory;
directing, by a processing module, a filter co-processor to perform filtering operations;
retrieving, by the filter co-processor, the digital audio information from the memory;
filtering, by the filter co-processor, the digital audio information to produce filtered digital audio information; and
storing the filtered digital audio information in the memory.

16. The method of claim 15, further comprising operating in a playback mode by:
retrieving the filtered digital audio information from the memory; and
converting the filtered digital audio information to a playback format.

17. The method of claim 16, wherein the filtering, by the filter co-processor, on the digital audio information to produce the filtered digital audio information comprises interpolation filtering.

18. The method of claim 16, wherein the filtering, by the filter co-processor, on the digital audio information to produce the filtered digital audio information comprises graphic equalizer filtering.

19. The method of claim 18, wherein graphic equalizer filtering includes one of subtractive graphic equalizer filtering in a cascade mode or additive graphic equalizer filtering in a parallel mode.

20. The method of claim 15, further comprising operating in a recording mode b:
receiving incoming audio information;
converts the incoming audio information to incoming digital audio information;
writing the incoming digital audio information to memory;
retrieving, by the filter co-processor, the incoming digital audio information from the memory;
filtering, by the filter co-processor, the incoming digital audio information to produce filtered incoming digital audio information; and
writing, by the filter co-processor, the filtered incoming digital audio information to the memory.

21. The method of claim 20, wherein filtering, by the filter co-processor, comprises decimation filtering on the incoming digital audio information to produce the filtered incoming digital audio information.

22. The method of claim 15, further comprising varying the frequency of a clock provided to the filter co-processor to thereby adjust the rate at which the filter-co-processor filters the digital audio information.

23. The method of claim 22, further comprising varying a supply voltage provided to the filter co-processor.

24. The method of claim 15, further comprising performing a context switch by ceasing ongoing filtering operations of the filter co-processor and initiating differing filtering operations of the filter co-processor.

25. The method of claim 25, further comprising saving a state of the current filtering operations to memory when performing the context switch.

26. An integrated circuit used in an audio playback device, the integrated circuit comprising:
means for receiving digital audio information via a host interface;
means for storing the digital audio information in memory;
means for directing, by a processing module, a filter co-processor to perform filtering operations;
means for retrieving, by the filter co-processor, the digital audio information from the memory;
means for filtering, by the filter co-processor, the digital audio information to produce filtered digital audio information; and
means for storing the filtered digital audio information in the memory.
